(19) United States
(12) Patent Application Publication
(10) Pub. No.: US 2002/0062760 A1
(43) Pub. Date: May 30, 2002

(54) Catalyst solutions useful in activating substrates for subsequent plating

(76) Inventors: Ronald Redline, Prospect, CT (US); Mark Wojtaszek, Burlington, CT (US)

Correspondence Address: John L. Cordani, Carmody & Torrance LLP, 50 Leavenworth Street, P.O. Box 1110, Waterbury, CT, 06721-1110, US

(21) Appl. No.: 10/053,784

(22) Filed: Jan. 22, 2002

Related U.S. Application Data
(63) Continuation-in-part of application No. 09/707,134, filed on Nov. 6, 2000.

(51) Int. Cl. C23C 18/18; B05D 3/10; B05D 1/36

(52) U.S. Cl. 106/1.11; 427/304; 427/404; 106/1.13; 106/1.22

(57) ABSTRACT

An improved colloidal activator is disclosed which is useful in preparing substrates for plating. The activator comprises a source of gold, a source of tin and an organic sulfonic acid. Relatively low levels of palladium have been found to be synergistically advantageous. In addition, sulfonated surfactants have also proven to be useful. The colloidal activator may also include colloid stabilizers. A method for preparing and a process for using the activator are also disclosed.

This application is a continuation-in-part of U. S. Ser. No. 09/707,134 filed on Nov. 6, 2000 and which is currently pending.

### FIELD OF THE INVENTION

The present invention relates to improved catalyst solutions useful in preparing substrates for plating thereupon.

### BACKGROUND ART

Metallization processes for non-conductive substrates using noble metal baths, primarily baths containing palladium, as activators are well known. These processes are particularly useful in applying functional and decorative metal coatings to non-conductive substrates such as glass and various plastics, and are particularly useful in metallizing printed circuit boards.

One of the earliest innovations in the area of activating substrates for subsequent plating employed a plurality of baths in which the substrate was subjected to a basic two-step activation process entailing immersion in a stannous chloride solution followed by immersion in an acidic palladium chloride solution. In some cases only immersion in the acidic palladium chloride solution was used, however, for many substrates and for many plating solutions this activation process was unacceptable.

Subsequent innovations combined the palladium and tin steps together into a single colloidal dispersion of palladium and tin. In this regard, please refer to U.S. Pat. No. 3,011,920 to Shipley, Jr. the teachings of which are incorporated herein by reference in their entirety. These colloidal dispersions of palladium and tin were and are currently widely used in activating substrates, particularly non-conductive substrates, for subsequent plating. However, the stability of the colloidal dispersion and the catalytic ability of the activator towards plating require improvement.

U.S. Pat. No. 3,672,938 to Zeblisky, the teachings of which are incorporated herein by reference in their entirety, discusses various improvements to these colloidal dispersions. Zeblisky proposes a metal complex consisting essentially of a precious metal selected from the group consisting of Group VIII and I-B of the Periodic Table of Elements, a Group IV metal which is capable of two valence states and an anion capable of forming a stable moiety with both valence states of the Group IV metal.

U.S. Pat. No. 4,863,758 to Rhodenizer, the teachings of which are incorporated herein by reference in their entirety, discloses further improvements to colloidal noble metal activation solutions. Rhodenizer discloses a composition for activating a substrate for electroless metallization comprising: a noble metal that is catalytic to a chemical reduction plating process, salts capable of forming a protective metal sol, and at least one organic acid, which is substantially soluble in the plating bath, selected from the group consisting of aliphatic carboxylic acids, aromatic carboxylic acids, amino acids and combinations of these.

It is an object of this invention to provide a single step, colloidal, noble metal activator with improved stability and catalytic activity towards plating.

### SUMMARY OF THE INVENTION

The inventors herein propose an activator solution comprising:

a. source of gold;

b. source of tin;

c. an acid which is preferably an organic sulfonic acid, most preferably methane sulfonic acid;

d. preferably, a source of palladium;

e. preferably, a surfactant of the following chemical structure:

R—(—SO₃H)ₓ wherein R comprises an alkyl or aromatic group and x is an integer; and

f. optionally, a colloid stabilizer.

The inventors have discovered that colloidal activator solutions of the foregoing ingredients, prepared as noted herein, provide significant advantages in terms of colloidal stability, catalytic activity and other performance factors.

### DETAILED DESCRIPTION OF THE INVENTION

As noted, an improved colloidal activator solution is prepared, comprising

a. source of gold;

b. source of tin;

c. an acid which is preferably an organic sulfonic acid;

d. optionally but preferably, a source of palladium;

e. optionally but preferably, a surfactant of the following chemical structure:

R—(—SO₃H)ₓ wherein R comprises an alkyl or aromatic group and x is an integer; and

f. optionally, a colloid stabilizer.

The source of gold may be any source that would supply gold containing ions or metal to the activator solution. Halogenated gold salts or acids are preferred. Examples of the most preferred gold sources are gold trichloride and tetrachloroauric acid. It is preferred for the concentration of gold (measured by gold content) in the activator colloid to range from about 0.01 to 15 g./l.

The source of tin is preferably a source of stannous tin. Examples of preferred tin sources are stannous chloride, stannous sulfate, or stannous methanesulfonic acid (stannous methane sulfonate), with stannous methansulfonic acid being the most preferred. It is preferred for the concentration of tin (measured as tin content) in the activator colloid to range from about 45 to 200 g/l.

The activator colloid should contain an acid, which is preferably an organic sulfonic acid, most preferably methane sulfonic acid. Other acids such as hydrochloric acid, or sulfuric acid may be present as well. The concentration of the acid in the activator colloid preferably ranges from about 1 to 5 moles per liter. As noted, the inventors have found that the use of organic sulfonic acids in the activator colloid are greatly preferred and produce a colloid with improved stability and catalytic activity. It is most preferred to use the organic sulfonic acid corresponding to the anion provided by the source of tin (i.e. tin methane sulfonate and methane sulfonic acid).

It is preferred that the activator solution comprise a source of palladium ions. The source of palladium may be any source that would supply palladium containing ions or metal to the activator solution. The inventors herein have discovered that the inclusion of a source of palladium at relatively low levels works synergistically with the gold to promote more efficient activation. Previous palladium based activators have generally contained palladium concentrations higher than 0.1 g/l. However, these inventors have discovered that the inclusion of palladium at concentrations ranging from 2 to 70 ppm, preferably from 5 to 50 ppm, in this activator composition provides activation which is superior to prior art activators containing much higher levels of palladium. The inventors believe that a synergism exists by combining gold and palladium in the activator composition of this invention. In this regard, the most preferred source of palladium is palladium chloride.

The inventors have also found that the inclusion of a surfactant of the following type:

R—(—SO₃H)ₓ

wherein R comprises an alkyl or aromatic group and x is an integer, preferably an integer from 1 to 3 will improve the catalytic activity of this activator composition, particularly over substrates comprising glass surfaces. Preferably R is an alkyl group, comprising at least 6 carbon atoms. Some commercial examples of surfactants useful in this invention include DOWFAX™ 2A1, DOWFAX™ 3B2, and TERGITOL™ 08, all available from Dow Chemical Company. The inventors have found that inclusion of a surfactant of this type in the activator composition improves the colloidal stability of the composition and improves the composition's ability to activate glass substrates, in particular. Preferably the concentration of the surfactant in the activator composition ranges from about 0.01 g/l to 10 g/l, most preferably from about 0.5 g/l to 5 g/l.

Optionally the activator colloid may also contain colloid stabilizers. Preferred colloid stabilizers include gum arabic, guar gum, xanthan gum and/or gelatin. If used, the concentration of the colloid stabilizer in the activator colloid may preferably range from 0.01% to 0.1% by weight.

The method of preparing the concentrated colloid is critical to the stability of the colloid formed and its catalytic activity. Thus first a gold containing solution should be prepared by mixing the gold source, and, if used, the palladium source, with the chosen organic sulfonic acid. A portion of the acid to be used in preparing the colloid should be mixed with the gold source in this first step. Next, a separate solution of the tin source, the other portion of the acid to be used in preparing the colloid, water and any other necessary ingredients such as surfactant and/or colloid stabilizer, is prepared. The gold containing solution is then added to the tin containing solution, slowly, with stirring, over a period of from 10 to 60 seconds. The reaction mixture is then stirred at room temperature for 2 hours. Alternatively, the reaction mixture may be rapidly heated, with stirring, to about 95° C. and when that temperature is reached, allowed to cool naturally with stirring. A third alternative is to heat the tin containing solution to about 95° and then add the gold containing solution to the tin containing solution over a period of from 10 to 60 seconds with stirring and allow the reaction mixture to cool naturally with stirring. Heating if used should be to between about 70° C. and about 95° C. but is preferably to about 95° C.

Once the concentrated activator colloid is prepared as above, the activator working bath is prepared by mixing from about 1 to 25% by volume of the concentrated activator colloid with water or an aqueous solution of sodium chloride, potassium chloride, acids, or mixtures of the foregoing. The working colloid should preferably contain from about 0.05 to 2 g/l of gold.

As noted this colloidal activator is useful in preparing substrates, particularly non-conductive substrates, for plating, usually by electroless or chemical reduction plating. Typical electroless plating processes that may utilize this colloidal activator in plating upon plastics may include the following steps:

a. a plastic etchant, which will etch the plastic surface such as chromic acid or potassium permanganate solutions.

b. a neutralizer to neutralize the plastic etchant residues such as hydroxylamine solutions.

c. a conditioner, which cleans the surface of the plastic and conditions it to receive activator species.

d. the working bath activator colloid

e. an acidic or alkaline accelerator used to enhance the catalytic activity of the activator species on the surface of the plastic.

f. an electroless plating bath, usually an electroless nickel or an electroless copper plating bath

The working bath activator colloid is applied to the substrate by merely contacting the surface to be activated with the colloid, usually by immersion therein for from about 30 seconds to 5 minutes. The temperature of the working activator colloid may range from room temperature to about 120° F., but is preferably from about 75° F. to about 85° F.

The foregoing invention is further described by the following examples, which should be considered illustrative but not limiting.

### EXAMPLE 1

A 600 mL beaker is charged with 125 mL methane sulfonic acid (70%) and 275 mL deionized water. With stirring and heating 150 grams (as tin) of stannous methane sulfonate is added. The volume is brought to 490 mL with deionized water. When the solution reaches 95° C., a mixture of 1.0 mL gold solution (31.1 grams gold per 100 mL) and 9 mL 6 N hydrochloric acid is added over a 15 second period. The heat is then turned off and the reaction mixture allowed to cool. The product is a dark purple-brown liquid containing 0.55 grams of gold per liter.

The gold activator colloid manufactured as in the process described above is then used to activate a non-conductive substrate such as an ABS plastic coupon for electroless plating. To activate the non-conductive substrate, the following steps were done:

1. The coupon surface is etched with a chromic acid/sulfuric acid mixture at 160° F. for 8 minutes.

2. The coupon is rinsed with deionized water for 1 minute.

3. The coupon is placed in a bath of Macuplex 9339 Neutralizer* at 85° F. for 2 minutes.

4. The coupon is rinsed with deionized water for 1 minute.

5. The coupon is placed in the activation bath consisting of a 10% v/v solution of the colloid as prepared above in an aqueous solution of 75 g/l sodium chloride and 1.5% by volume hydrochloric acid (37%).

6. The coupon is rinsed with deionized water for 1 minute.

7. The coupon is placed in MacDermid Ultracel 9369 Accelerator* at 120° F. for 2 minutes.

8. Coupon is rinsed with deionized water for 1 minute.

9. Activated coupon is placed in MacDermid Macuplex J-64 Electroless Nickel* at 90° F. for 10 minutes.

10. The coupon is rinsed in deionized water for 2 minutes, then air-dried. The activated coupon plated with a uniform gray nickel coating, 8 millionths inch thickness.

*—available from MacDermid, Incorporated, 245 Freight Street, Waterbury, Conn. 06702.

### EXAMPLE 2

To demonstrate the usefulness of the gold colloid for activating printed circuit boards for electroless copper plating, a gold colloid manufactured as described in example 1 was used to activate a double sided copper clad panel with through holes as follows:

1. The panel is placed in a bath of M-Treat BIO hole conditioner* at 110° F. for 5 minutes.

2. The panel is rinsed in deionized water for 2 minutes.

3. The panel is placed in a bath of M-Permanganate P* at 165° for 10 minutes.

4. The panel is rinsed in deionized water for 8 minutes.

5. The panel is placed in a bath of M-Neutralize* at 110° for 5 minutes.

6. The panel is rinsed in deionized water for 4 minutes.

7. The panel is placed in a bath of M-Condition Conditioner/Cleaner* at 125° F. for 5 minutes.

8. The panel is rinsed in deionized water for 5 minutes.

9. The panel is placed in a bath of Macuprep Etch G4 Microetch* at 90° F. for 1 minute.

10. The panel is rinsed in deionized water for 2 minutes.

11. The panel is placed in a bath of Metex 9008 PreDip* at ambient temperature for 1 minute.

12. The panel is placed in a bath consisting of 10% of a gold colloid prepared as in Example 1 in an aqueous solution of 75 g/l sodium chloride and 1.5% by volume hydrochloric acid (37%) at 90° F. for 5 minutes.

13. The panel is rinsed with deionized water for 1.5 minutes.

14. The panel is placed in a bath of M-Accelerate* at 125° F. for 2.5 minutes.

15. The panel is rinsed in deionized water for 1 minute.

16. The panel is plated in M-Copper 85 Electroless Copper* at 115° F. for 30 minutes.

17. The panel was rinsed with deionized water for 6 minutes then air-dried

* available from MacDermid, Incorporated, 245 Freight Water, Waterbury, Conn. 06702.

The panel had a uniform copper coating. Backlight examination of the plated holes were done and given a rating of 10 from scale of 1-10 with a rating of 10 meaning complete coverage of the hole with no light visible showing through.

### EXAMPLE 3

A 600 ml beaker is charged with 125 ml methane sulfonic acid (70%) and 275 ml deionized water. With stirring and heating 150 grams (as tin) of stannous methane sulfonate is added. The volume is brought to 4.90 ml. With deionized water. When the solution containing 0.311 grams of gold ion and 0.025 grams of palladium ion and 9 ml 6 N hydrochloric acid is added over a 15 second period. The heat is then turned off and the reaction mixture allowed to cool. The product is a dark purple-brown liquid.

The gold-palladium colloid manufactured as described above is then used to activate an epoxy-inpregnated glass cloth for electroless plating. In doing so the epoxyglass coupon is placed in an activation bath consisting of a 10% v/v solution the activator colloid in an aqueous solution of 75 g/l sodium chloride and 1.5% v/v hydrochloric acid (37%). Next the coupon is rinsed with deionized water and treated with MacDermid MAccelerate (available from MacDermid, Incorporated of Waterbury, Conn.) at 125° F. fro 2.5 minutes. The coupon is once again rinsed in deionized water and then placed in MCopper 85 Electroless Copper Plating Solution (available from MacDermid, Incorporated) at 115° F. for 30 minutes. Finally the coupon is rinsed and dried.

The plated coupon exhibited excellent copper coverage with a rating of about 9 on a scale of 1-10.

### EXAMPLE 4

Example 3 is repeated, except that this time 1 g/l of Dowfax 2A1 surfactant was added to the stannous methane sulfonate solution prior to adding the gold-palladium solution.

The plated coupon exhibited excellent copper coverage with a rating of about 10 (complete coverage) on a scale of 1-10.

What is claimed is:

1. A composition useful in activating a substrate for metallization, said composition comprising:
a. source of gold;
b. source of tin;
c. organic sulfonic acid; and
d. a source of palladium.

2. A composition according to claim 1 comprising a gold-tin colloidal dispersion.

3. A composition according to claim 1 wherein the source of gold is selected from the group consisting of gold trichloride, tetrachloroauric acid, and mixtures thereof.

4. A composition according to claim 1 wherein the composition also comprises a surfactant with the following chemical structure:
R—(—SO₃H)ₓ
wherein R comprises an alkyl or aromatic group and x is an integer.

5. A composition according to claim 1 wherein the organic sulfonic acid is methane sulfonic acid.

6. A composition according to claim 1 also comprising a colloid stabilizer selected from the group consisting of gum arabic, guar gum, xanthan gum, gelatin, and mixtures of the foregoing.

7. A composition according to claim 1 comprising from 0.01 to 15 g/l gold, from 45 to 200 g/l tin, from 1 to 5 moles per liter of organic sulfonic acid and less than about 50 ppm of palladium.

8. A composition according to claim 2 wherein the source of gold is selected from the group consisting of gold trichloride, tetrachloroauric acid, and mixtures thereof.

9. A composition according to claim 2 wherein the source of tin is selected from the group consisting of stannous chloride, stannous sulfate, stannous methane sulfonate, and mixtures thereof.

10. A composition according to claim 2 wherein the organic sulfonic acid is methane sulfonic acid.

11. A composition according to claim 2 also comprising a colloid stabilizer selected from the group consisting of gum arabic, guar gum, xanthan gum, gelatin, and mixtures of the foregoing.

12. A composition according to claim 2 also comprising from 0.01 to 15 g/l gold, from 45 to 200 g/l tin, from 1 to 5 moles per liter of organic sulfonic acid and less than about 50 ppm of palladium.

13. A composition according to claim 9 wherein the organic sulfonic acid is methane sulfonic acid.

14. A composition according to claim 13 also comprising a colloid stabilizer selected from the group consisting of gum arabic, guar gum, xanthan gum, gelatin, and mixtures of the foregoing.

15. A composition according to claim 14 comprising from 0.01 to 15 g/l gold, from 45 to 200 g/l tin, from 1 to 5 moles per liter of organic sulfonic acid and less than about 50 ppm of palladium.

16. A process for plating a substrate, said process comprising:
a. contacting the substrate with an activator comprising:
1. source of gold;
2. source of tin;
3. organic sulfonic acid; and
4. a source of palladium; and subseqently
b. contacting the substrate substrate with a plating solution comprising ions of a metal which is less noble than gold.

17. A process according to claim 16 wherein the activator comprises a gold-tin colloidal dispersion.

18. A process according to claim 16 wherein the source of gold is selected from the group consisting of goldtrichloride, tetrachloroauric acid, and mixtures thereof.

19. A process according to claim 16 wherein the activator also comprises a surfactant with the following chemical structure:
R—(—SO₃H)ₓ
wherein R comprises an alkyl or aromatic group and x is an integer.

20. A process according to claim 16 wherein the organic sulfonic acid is methane sulfonic acid.

21. A process according to claim 16 wherein the activator also comprises a colloid stabilizer selected from the group consisting of gum arabic, guar gum, xanthan gum, gelatin, and mixture of the forgoing.

22. A process according to claim 16 wherein the activator comprises from 0.01 to 15 g/l gold, from 45 to 200 g/l tin, and from 1 to 5 moles per liter of organic sulfonic acid and less than about 50 ppm of palladium.

23. A process according to claim 19 wherein the source of gold is selected from the group consisting of goldtrichloride, tetrachloroauric acid, and mixtures thereof.

24. A process according to claim 19 wherein the source of tin is selected from the group consisting of stannous chloride, stannous sulfate, stannous methane sulfonate, and mixtures thereof.

25. A process according to claim 19 wherein the organic sulfonic acid is methane sulfonic acid.

26. A process according to claim 19 also comprising a colloid stabilizer selected from the group consisting of gum arabic, guar gum, xanthan gum, gelatin, and mixtures of the forgoing.

27. A process according to claim 19 wherein the activator comprises from 0.01 to 15 g/l gold, from 45 to 200 g/l tin, from 1 to 5 moles per liter of organic sulfonic acid and less than about 50 ppm of palladium.

28. A process according to claim 24 wherein the organic sulfonic acid is methane sulfonic acid.

29. A process according to claim 28 also comprising a colloid stabilizer selected from the group consisting of gum arabic, guar gum, xanthan gum, gelatin, and mixtures of the forgoing.

30. A process according to claim 29 wherein the activator comprises from 0.01 to 15 g/l gold, from 45 to 200 g/l tin, from 1 to 5 moles per liter of organic sulfonic acid and less than about 50 ppm of palladium.

31. A method for forming a colloidal catalyst, said method comprising:
a. preparing a gold containing solution comprising gold ions, palladium ions, and an acid;
b. preparing a tin containing solution comprising stannous tin ions and an acid;
c. adding the gold containing solution to the tin containing solution with stirring to create an activator;
d. continuing to stir the activator until a colloidal tin-gold dispersion is formed.

32. A method according to clam 31 wherein the activator is heated to from about 70° C. to about 95° C. and then cooled.

33. A method according to claim 31 wherein the tin containing solution is heated to between about 70° C. to about 95° C. prior to adding the gold containing solution.

34. A method according to claim 31 wherein the acid is an organic sulfonic acid.

35. A method according to claim 32 wherein the acid is an organic sulfonic acid.

36. A method according to claim 33 wherein the acid is an organic sulfonic acid.

37. A method according to claim 31 wherein the tin containing solution also comprises a surfactant with the following chemical structure:
R—(—SO₃H)ₓ
wherein R comprises an alkyl or aromatic group and x is an integer.

38. A composition useful in activating a substrate for metallization, said composition comprising:
a. source of gold;
b. source of tin;
c. acid; and
d. a surfactant with the following chemical structure:
R—(—SO₃H)ₓ
wherein R comprises an alkyl or aromatic group and x is an integer.

39. A composition according to claim 38 wherein the composition also comprises a source of palladium.

40. A composition according to claim 38 wherein the acid is an organic sulfonic acid.

41. A composition according to claim 38 wherein the composition also comprises a colloid stabilizer selected from the group consisting of gum arabic, guar gum, xanthen gum, gelatin and mixtures of the foregoing.

42. A composition according to claim 38 comprising from 0.01 to 15 g/l gold, from 45 to 200 g/l tin, from 1 to 5 moles per liter of acid and less than about 50 ppm palladium.
